(19) United States
(12) Patent Application Publication
(10) Pub. No.: US 2007/0156347 A1
(43) Pub. Date: Jul. 5, 2007

(54) Using a biological recording to obtain time values

(75) Inventors: Roderick A. Hyde, Livermore, CA (US); Edward K.Y. Jung, Bellevue, WA (US); Royce A. Levien, Lexington, MA (US); Robert W. Lord, Seattle, WA (US); Mark A. Malamud, Seattle, WA (US); John D. Rinaldo JR., Bellevue, WA (US); Lowell L. Wood JR., Livermore, CA (US)

Correspondence Address: SEARETE LLC;CLARENCE T. TEGREENE, 1756 - 114TH AVE., S.E., SUITE 110, BELLEVUE, WA, 98004, US

(73) Assignee: Searete LLC

(21) Appl. No.: 11/343,966

(22) Filed: Jan. 31, 2006

Related U.S. Application Data
(63) Continuation-in-part of application No. 11/323,832, filed on Dec. 30, 2005.
(63) Continuation-in-part of application No. 11/343,944, filed on Jan. 31, 2006.

(51) Int. Cl. G06F 19/00

(52) U.S. Cl. 702/19

(57) ABSTRACT

A method and system are described for establishing one or more reference time values indicative of a systemic flow of one or more markers to an outgrowth and indicating one or more event time values partly based on a signal from the outgrowth and partly based on the one or more reference time values.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC § 119(e) for provisional patent applications, for any and all parent, grandparent, great-grandparent, etc. applications of the Related Application(s)).

### RELATED APPLICATIONS

For purposes of the USPTO extra-statutory requirements, the present application constitutes a continuation-in-part of U.S. patent application Ser. No. 11/323,832, entitled MODULATING A BIOLOGICAL RECORDING WITH ANOTHER BIOLOGICAL RECORDING, naming Roderick A. Hyde; Edward K. Y. Jung; Royce A. Levien; Robert W. Lord; Mark A. Malamud; John D. Rinaldo, Jr. and Lowell L. Wood, Jr. as inventors, filed 30 Dec. 2005, which is currently co-pending, or is an application of which a currently co-pending application is entitled to the benefit of the filing date.

For purposes of the USPTO extra-statutory requirements, the present application constitutes a continuation-in-part of U.S. patent application Ser. No. ______, entitled ESTABLISHING A BIOLOGICAL RECORDING TIMELINE BY ARTIFICIAL MARKING, naming Roderick A. Hyde; Edward K. Y. Jung; Royce A. Levien; Robert W. Lord; Mark A. Malamud; John D. Rinaldo, Jr. and Lowell L. Wood, Jr. as inventors, filed contemporaneously herewith, which is currently co-pending, or is an application of which a currently co-pending application is entitled to the benefit of the filing date [Attorney Docket No. 0905-002-019A-000000]. The United States Patent Office (USPTO) has published a notice to the effect that the USPTO's computer programs require that patent applicants reference both a serial number and indicate whether an application is a continuation or continuation-in-part. Stephen G. Kunin, Benefit of Prior-Filed Application, USPTO Official Gazette Mar. 18, 2003, available at http://www.uspto.gov/web/offices/com/sol/og/2003/week11/patbene.htm. The present applicant entity has provided above a specific reference to the application(s) from which priority is being claimed as recited by statute. Applicant entity understands that the statute is unambiguous in its specific reference language and does not require either a serial number or any characterization, such as “continuation” or “continuation-in-part,” for claiming priority to U.S. patent applications. Notwithstanding the foregoing, applicant entity understands that the USPTO's computer programs have certain data entry requirements, and hence applicant entity is designating the present application as a continuation-in-part of its parent applications as set forth above, but expressly points out that such designations are not to be construed in any way as any type of commentary and/or admission as to whether or not the present application contains any new matter in addition to the matter of its parent application(s).

All subject matter of the Related Applications and of any and all parent, grandparent, great-grandparent, etc. applications of the Related Applications is incorporated herein by reference to the extent such subject matter is not inconsistent herewith.

### SUMMARY

An embodiment provides a method. In one implementation, the method includes but is not limited to establishing one or more reference time values indicative of a systemic flow of one or more markers to an outgrowth and indicating one or more event time values partly based on a signal from the outgrowth and partly based on the one or more reference time values. In addition to the foregoing, other method aspects are described in the claims, drawings, and text forming a part of the present disclosure.

In one or more various aspects, related systems include but are not limited to circuitry and/or programming for effecting the herein-referenced method aspects; the circuitry and/or programming can be virtually any combination of hardware, software, and/or firmware configured to effect the herein-referenced method aspects depending upon the design choices of the system designer.

An embodiment provides a system. In one implementation, the system includes but is not limited to circuitry for establishing one or more reference time values indicative of a systemic flow of one or more markers to an outgrowth and indicating one or more event time values partly based on a signal from the outgrowth and partly based on the one or more reference time values. In addition to the foregoing, other system aspects are described in the claims, drawings, and text forming a part of the present disclosure.

In addition to the foregoing, various other embodiments are set forth and described in the text (e.g., claims and/or detailed description) and/or drawings of the present description.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 depicts an exemplary environment in which one or more technologies may be implemented.

FIG. 2 depicts a highly magnified view of two strands of hair in situ, with a sensor positioner shown for illustration.

FIG. 3 depicts a plot of several parameters as periodically sampled functions each relating to a secretion or secretion parameter.

FIG. 4 depicts a high-level logic flow of an operational process.

FIG. 5 depicts several variants of the flow of FIG. 4.

FIG. 6 depicts several variants of the flows of FIG. 4 or FIG. 5.

FIG. 7 depicts several other variants of the above-mentioned flows.

FIG. 8 depicts several further variants of the above-mentioned flows.

FIG. 9 depicts several further variants of the above-mentioned flows.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

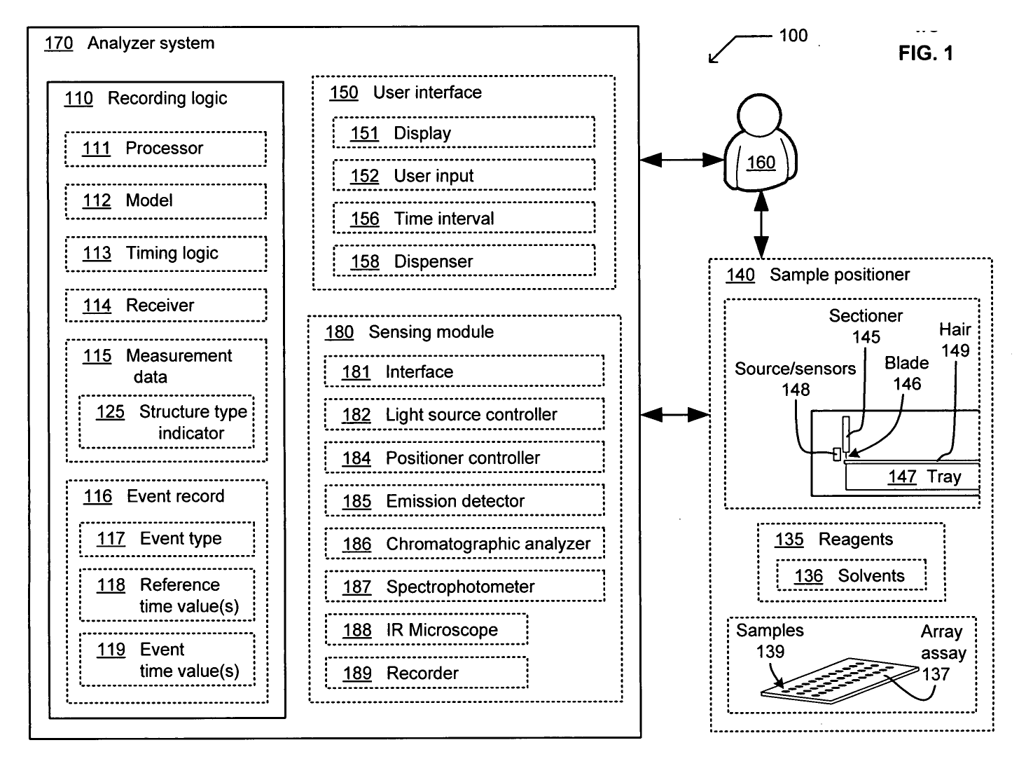

Referring now to FIG. 1, there is shown an exemplary environment in which one or more technologies may be implemented. Lab system 100 includes analyzer system 170, and may include sample positioner 140 also, operable by user 160. Analyzer system 170 includes recording logic 110 and may include user interface 150 or sensing module 180 (or both, as explained at the end of this section). Recording logic 110 may include one or more of processor 111, model 112, timing logic 113, receiver 114, measurement data 115 from an outgrowth, or event record 116. Measurement data 115 may include structure type indicator 125. Event record 116 may include one or more of event type 117, reference times value(s) 118, or event time value(s) 119. Event type 117 may include a marker or marking substance identification, a climate indicator or other environmental status descriptor, a descriptor of a symptom onset or other subject-specific event, or an identifier of an anomaly or other significant change in a signal, for example.

Part or all of measurement data 115 or event record 116 can optionally be analog or digital, scalar- or matrix-valued, and may be buffered, stored, or merely transmitted. Moreover these items may comprise an array of stored values, a message, a control signal, a historical record, or simply an XY-plot or other outcome presented or offered to user 160 via user interface 150 or otherwise used or sent through an external linkage.

In some embodiments, user interface 150 includes one or more of display 151, user input 152, a time interval 156, or a dispenser 158 as exemplified below. These embodiments optionally include sensing module 180 comprising one or more of interface 181, light source controller 182, positioner controller 184, emission detector 185, chromatographic analyzer 186, spectrophotometer 187, infrared (IR) microscope 188, and recorder 189.

Sensing module 180 may include one or more of light source controller 182, positioner controller 184, emission detector 185, chromatographic analyzer 186, spectrophotometer 187, IR microscope 188, or recorder 189. Alternatively or additionally, sensing module 180 can include interface 181 operable to transmit measurement data 115 to receiver 114 or to user interface 150. For example, interface 181 can optionally be operable to request, control or otherwise obtain measurement data 115 from one or more network-accessible, remote, or other external systems such as an analyzer, a spectroscope, a microscope, or a computing system.

Sample positioner 140 optionally includes one or more of solvents 136 or other reagents 135, one or more of array assay 137 containing samples 139, or sectioner 145. As shown in relation to sectioner 145, source/sensors 148 can optionally be included to measure one or more optical responses of a left-most end of hair 149 to a controlled emission from source/sensors 148. As shown, sectioner 145 is controllable to manipulate blade 146 to cut hair 149 very precisely, such as by actuating blade 146 with one or more piezo stacks or MEMS devices (not shown). In this optional example, tray 147 is similarly controllable to translate left (carrying hair 149) or otherwise to push hair 149 left very precisely for further cuttings or measurements, such as by using a stepper motor (not shown). Those skilled in the art can readily implement sectioner 145 with other cutting mechanisms as well, such as a laser or a fine grinding surface. Sectioner 145 can alternatively be implemented as a row or other array of cells each containing a solvent into which an end of hair 149 is dipped (array assay 137, e.g.).

Array assay 137 can contain 36 (forward or reverse) sequential samples of a uniform length of hair, for example, so that each row of three cells receives a sample before proceeding to the next row. In this way each column of 12 cells has a (forward or reverse) sequence of 12 samples temporally and axially interspersed with the other two columns. Such an array can allow for a different testing regimen for each of the three columns even while preserving the sequencing, and even for a sample as small as one or two strands, whether the testing regimen is destructive or not.

It is contemplated that some embodiments of lab system 100 include sample positioner 140, as indicated by its dashed border, and that some do not. For example, samples and/or signals may be received directly in some embodiments of analyzer system 170, in which case lab system 100 can function well even without sample positioner 140 and even without directly accessing any samples.

In some embodiments involving sectioner 145, however, tray 147 can move hair 149 left so far that it extends well beyond source/sensors 148, after which source/sensors 148 can optionally be used for measuring one or more optical properties of a lateral surface of hair 149. In a variant configuration (not shown), a similar configuration of one or more lasers and one or more sensors are positioned “upstream” from sectioner 145 relative to the (leftward) motion of hair 149.

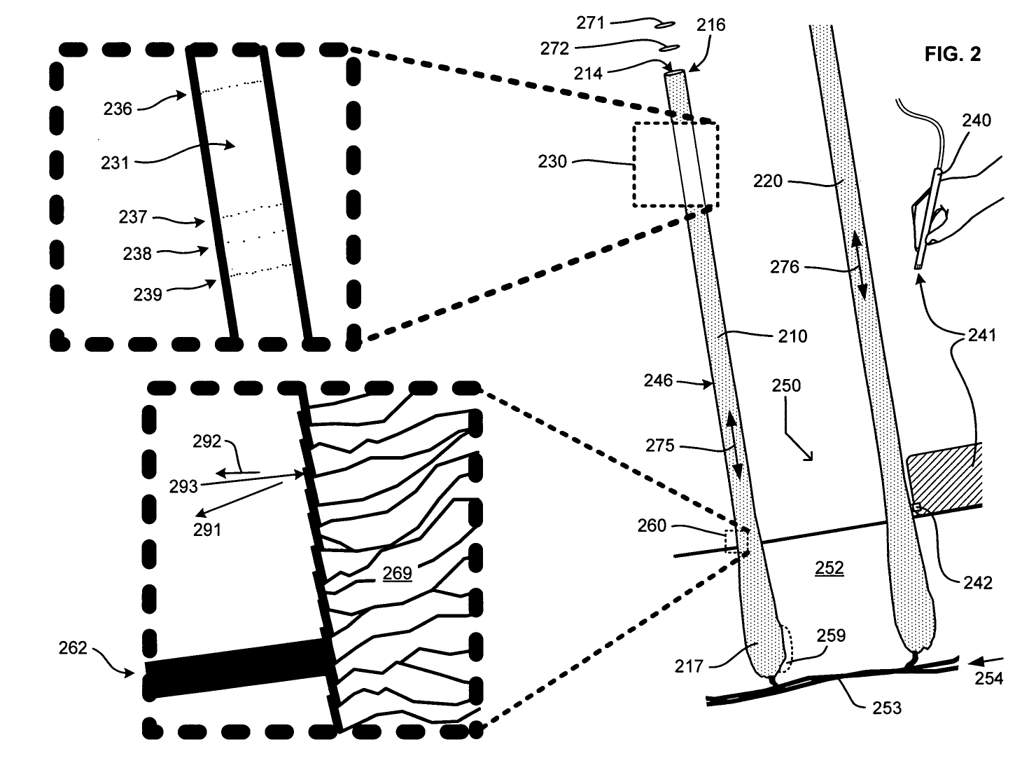

Turning now to FIG. 2, there is shown a highly magnified view of two in situ hairs 210, 220 which remain affixed with skin 252 of subject 250 as shown. Hair 210 is substantially aligned along axis 275 within a range of interest longer than several sample diameters, and hair 220 is substantially aligned along parallel axis 276 within its (shown) range of interest.

Circulatory system (adequately shown as a blood vessel for present purposes) 253 carries blood in a flow 254 that nourishes hair 210 at root 217. Root 217 is the most extreme proximal portion of hair 210, and is also firmly attached to skin tag 259. As shown, portion 271 and portion 272 have been removed from the distal portion of hair 210, which includes surface 214 at end 216. As described below, some embodiments relate to samples of a hair or other outgrowth for which an orientation or growth rate indicator can be useful.

Referring again to hair 210, a more magnified view of longitudinal portion 230 is provided. At least sebum layer 246 has been removed from longitudinal portion 230, revealing lateral surface 231, an exposed portion of the cortex of hair 210. Even without dissolving the cortex of longitudinal portion 230, as described below, it may be possible to detect one or more of an earlier-made marking 236, a naturally-occurring marker 237, a contaminant 238, or a later-made marking 239.

FIG. 2 also provides a more magnified view of lateral portion 260 of hair 210 at skin line 262. That magnified view clearly shows how sebum layer 246 comprises outward-tilting plates 269 that can help establish an orientation of hair 220, for example. The plates are optically asymmetrical, so that for example, incident light 293 roughly perpendicular to axis 275 is reflected roughly along ray 291 more than along ray 292. This is one of the inherent asymmetries that can be used in some embodiments so that timing logic 113 can determine a signal or sample orientation.

FIG. 2 also shows a hand-held positioner 240 that includes one or more supports 241 (tines, e.g) that bear one or more transducers 242 (sensors or lenses, e.g.) or guide a sample along relative to the one or more transducers 242 (by sliding an inter-tine groove upward or downward along hair 220, e.g.). As shown, positioner 240 is attached via a cord but can likewise be implemented with another type of signal-bearing medium such as an antenna.

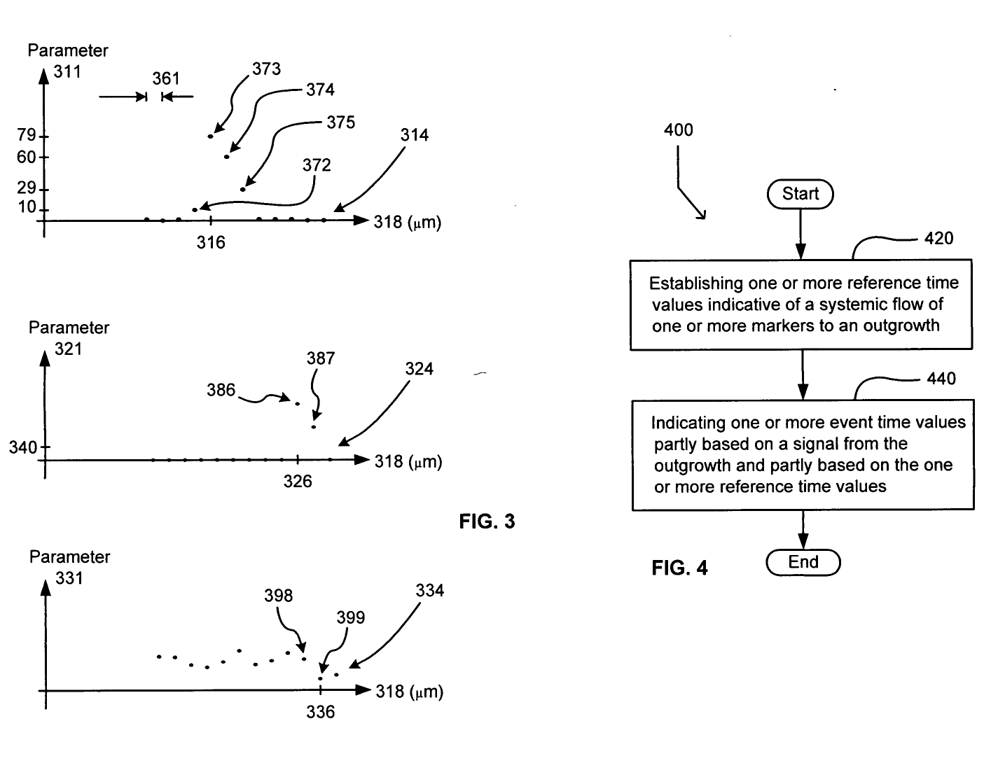

Referring now to FIG. 3, there is shown a plot of parameter 311 as a periodically sampled function 314 of distance 318 such as can obtained by analyzing a first one of the columns of twelve cells of array assay 137 described above. Also shown are plots of parameter 321 and parameter 331 as periodically sampled function 324 and periodically sampled function 334 of distance 318, respectively. Each of these several parameters 311, 321, 331 can be a concentration, a radioactivity, a luminescence, a magnetic response, an electrical resistance or capacitance, a reactivity with an analyte, a bacteria concentration, a temperature, a ratio, or substantially any axially variable, measurable or calculable quantity. In some embodiments in which the outgrowth exhibits a substantially steady, approximately known axial rate, function 314 adequately represents parameter 311 plotted versus time as well.

Function 314 comprises a series of 12 samples having a uniform sampling interval 361 (obtained as a length corresponding to about 3×time interval 156, e.g.) and a detectable peak (at sample 373) at position 316. As shown, measured or calculated values of parameter 311 are 10 (at sample 372), 79 (at sample 373), 60 (at sample 374, and 29 (at sample 375). Function 324 comprises a similar series of 12 samples in which sample 386 and sample 387 exhibit a similar detectable peak (above threshold 340, e.g.) at position 326. Function 334 likewise exhibits a detectable transition at or between sample 398 and sample 399, at position 336. Outgrowth samples in the 36 cells of array assay 137 can be assigned so that a first longitudinal 1/36 segment yields the first point of function 314, the second segment yields the first point of function 324, the third segment yields the first point of function 334, the fourth segment yields the second point of function 314, and so on in an interleaved pattern to generate functions 314, 324, & 334. In some embodiments the outgrowth sample sizes can be irregular, such as for non-cylindrical outgrowths, for signals expressible as an isotopic ratio or a concentration, or for enhancing a trace signal level in a region of interest.

When a peak, trend, transition, or other marking pattern is detected in one or more signals extracted from a biological recording, those skilled in the art will recognize in light of these teachings that an inference concerning rate or orientation can often be drawn from a timing measurement, computation, or other estimate responsive to the pattern. In some embodiments, for example, parameter 311 indicates a first marker and parameter 321 indicates a second marker. Timing information indicating which of these markers were in a systemic flow later can be used to draw an inference about whether or not distance 318 correlates with successively older outgrowth samples. (Note that parameter 311 or parameter 321 can be a natural marker in some embodiments.) Timing information indicating an offset time between the flows can likewise be used in scaling, for example by estimating an amount of time corresponding with sampling interval 361. Additional examples are provided below.

Referring now to FIG. 4, there is shown a high-level logic flow 400 of an operational process. Operation 420 shows establishing one or more reference time values indicative of a systemic flow of one or more markers to an outgrowth (e.g., event record 116 recording one or more reference time values 118 responsive to user input 152). In some embodiments, one or more of the reference time values are established by dispensing a marker-containing capsule to a subject, such as by dispenser 158. In some embodiments, the one or more artificial markers include an artificial toxin, a drug, a dye, one or more radioisotopes, a mixture, or other chemical component in a flow sufficient to deposit a detectable quantity in the outgrowth. Alternatively or additionally, the marker(s) can include a heavy metal trace or other natural material selected pro hoc and deposited in a detectable volume for marking the outgrowth via a systemic flow. (The flow can be intentional, spontaneous, artificial, sporadic, or otherwise.)

Operation 440 shows indicating one or more event time values partly based on a signal from the outgrowth and partly based on the one or more reference time values (e.g. display 151 indicating a date at which an outgrowth was apparently affected by an event). In some embodiments, the one or more event time values 119 are generated and transmitted by processor 111 or otherwise by recording logic 110. In some embodiments, the signal is received from spectrophotometer 187 detecting an atypically high (unhealthy) level of mercury, lead, aluminum, iron, nickel, arsenic, or cadmium can, for example, which can be detected even after a systemic flow or other metabolic processes, chemical or otherwise.

Alternatively or additionally, a timing estimate per se may be the only aspect of the record that is responsive to the flow. In some embodiments, measurement data from separate samples can optionally be combined, for example to align samples or achieve a desired signal-to-noise ratio. See, e.g., U.S. patent application Ser. No. 11/323,832, “Modulating a Biological Recording with Another Biological Recording” filed 30 Dec. 2005 by Hyde et al. and co-owned herewith. In one implementation, recording logic 110 indicates in event record 116 that sebum layer 246 contained a cocaine analyte that apparently marked hair 210 during the week of June 11. In some embodiments, a more reliable marking-timing estimate for an outgrowth section (a sebum, e.g.) is generated based on an artificial marking in the same outgrowth section. In an implementation like the one mentioned above, in which a marker is detected on a surface layer such as a sebum, event record 116 includes an indication that the marker was absent from each reading adjacent the positive reading(s). (This can indicate that the positive readings are likely to have arisen through a systemic flow rather than through a post-emergence application of the marker.) Alternatively or additionally, in some embodiments, recording logic 110 can use more than one kind of marking in a common outgrowth section (a cortex, e.g.) so as to reduce an error/offset arising from differing systemic routes to the outgrowth.

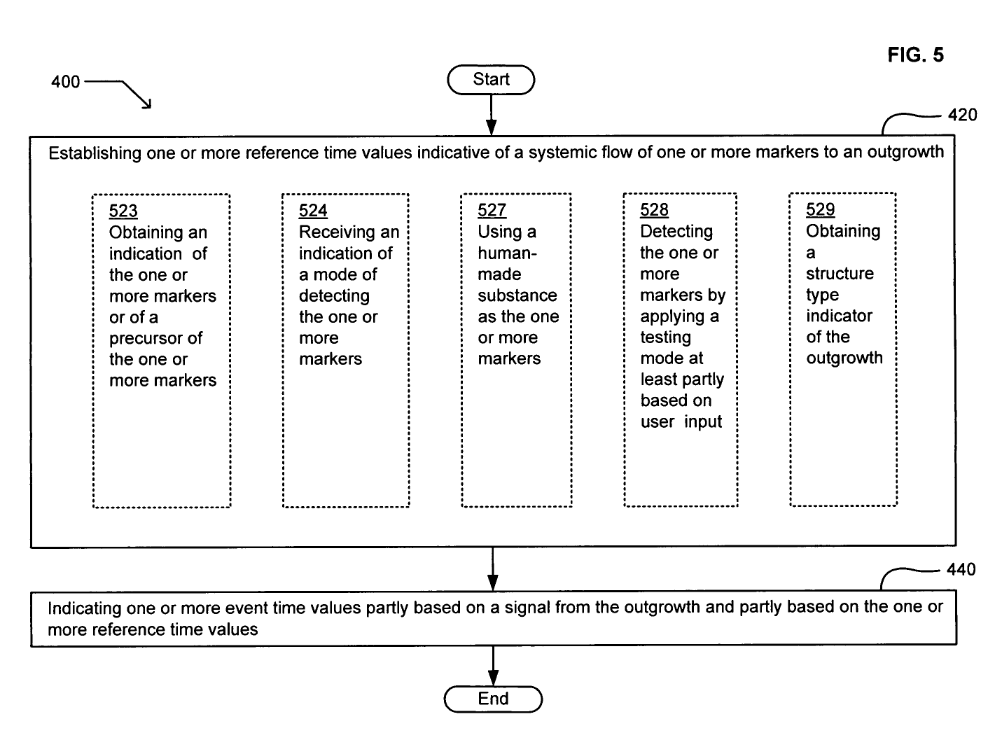

Referring now to FIG. 5, there are shown several variants of the flows 400 of FIG. 4. Operation 420—establishing one or more reference time values indicative of a systemic flow of one or more markers to an outgrowth—may (optionally) include one or more of the following operations: 523, 524, 527, 528, or 529. Operation 523 describes obtaining an indication of the one or more markers or of a precursor of the one or more markers (user interface 150 receiving user input 152 including an indication that a patient may have ingested a dangerous level of an aluminum-containing alloy over the past few months, e.g.). In other embodiments, dispenser 158 can record an identification of the marker- or precursor-containing product as it is being dispensed to user 160 (a patient or clinician, e.g.). Many of the carbohydrate compounds described below in conjunction with operation 645, for example, can be used as precursor(s) for producing detectable enzymes or lipids in an outgrowth. Alternatively or additionally, a precursor containing a heavy metal (in a first chemical form) can be detected later (whether in an original form or a metabolized form) by a spectrophotometer.

Operation 524 describes receiving an indication of a mode of detecting the one or more markers. User interface 150 or sensing module 180 can receive an IP address or equipment identifier of emission detector 185, chromatographic analyzer 186, or infrared (IR) microscope 188, for example. In some embodiments, the indication can include a process number or other identifier (“elemental analysis,” e.g.), a marker description (“containing aluminum,” e.g.), or a substance identifier (an enzyme or other analyte, e.g.).

Operation 527 describes using a human-made substance as the one or more markers (e.g. dispenser 158 dispensing a medication including a fluorescent dye or other optically detectable compound, e.g.). In some embodiments, two or more distinct markers may be buffered differently so that their respective systemic flows differ by at least an hour.

Operation 528 describes detecting the one or more markers by applying a testing mode at least partly based on user input (e.g. sensing module 180 deciding which one or more of emission detector 185, chromatographic analyzer 186, spectrophotometer 187, or IR microscope 188 to use, responsive to user input 152 from user interface 150). Alternatively or additionally, the testing mode can depend on a structure type indicator 125 (“eyelash,” e.g.) received via an earlier state of user input 152.

Operation 529 describes obtaining a structure type indicator of the outgrowth (e.g. processor 111 receiving as user input 152 an indication that an outgrowth has a structure type of “claw/nail” and using structure type indicator 125 in processing other measurement data). Alternatively or additionally, recording logic 110 may be configured to determine that samples 139 have a structure type indicator of “57” (indicating a cat whisker, e.g.) based on spectrophotometry, on colorimetry, or on image recognition testing like that of U.S. patent application Ser. No. 11/091,142 (“Systems and Methods for Face Detection And Recognition Using Infrared Imaging”), filed 13 Oct. 2005 by Maneesh Singh et al. See also U.S. patent application Ser. No. 11/129,034 (“Image-Based Search Engine for Mobile Phones with Camera”), filed 19 Jan. 2006 by Hartmut Neven, Sr., et al.; and U.S. patent application Ser. No. 11/044,188 (“Learning Method and Device for Pattern Recognition”), filed 25 Aug. 2005 by Masakazu Matsugu et al.

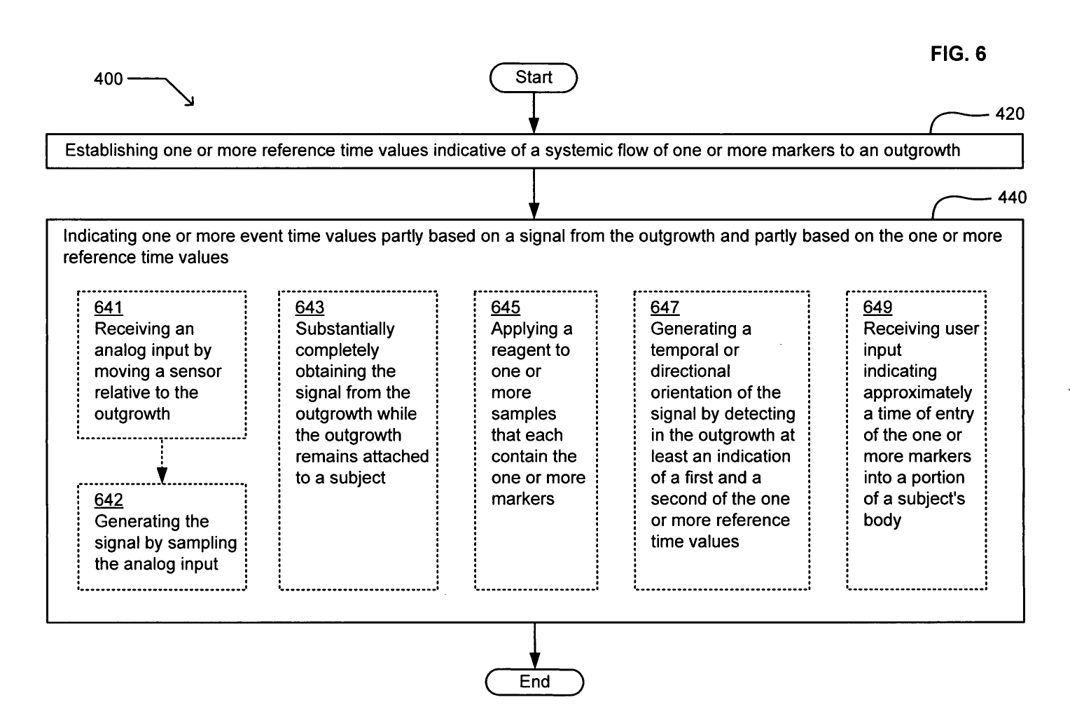

Referring now to FIG. 6, there are shown several variants of the flows 400 of FIG. 4 or FIG. 5. Operation 440—indicating one or more event time values partly based on a signal from the outgrowth and partly based on the one or more reference time values—may include one or more of the following operations: 641, 642, 643, 645, 647, or 649. Operation 641 describes receiving an analog input by moving a sensor relative to the outgrowth (e.g. receiver 114 receiving measurement data 115 as an analog voltage or optical signal received via transducer 242 as one or more supports 241 move transducer 242 along hair 220). In some embodiments, receiver 114 receives an analog signal as sample positioner 140 comprises a sensor or other transducer protruding from an end of a pencil-like probe for conveniently scanning along an exposed age-gradient portion of a tusk or toenail, for example.

Operation 642 describes generating the signal by sampling the analog input (e.g., timing logic 113 sampling measurement data 115 in analog form each sampling interval 361 and providing the resulting signal as function 334). In some embodiments, operation 440 includes receiving measurement data 115 or “the signal” in analog form.

Operation 643 describes substantially completely obtaining the signal from the outgrowth while the outgrowth remains attached to a subject (e.g. transducer 242 reading the outgrowth in situ). In some embodiments, recording logic 110 can determine an orientation of the structure substantially as described above in reference to light 293. In some embodiments, the signal comprises measurement data 115 initially obtained as a two-dimensional image.

Operation 645 describes applying a reagent to one or more samples that each contain the one or more markers (sample positioner 140 exposing samples 139 to one or more of sodium thioglycolate, lime, or calcium hydrosulfide). Alternatively or additionally, the samples 139 can be analyzed via spectrophotometer or otherwise tested for optical properties via emission detector 185. In some embodiments in which reagents 135 comprise enzymes, the marker can be a sugar or sugar derivative such as arabinose, erythrulose, myo-inositol, cis-inositol, mannitol, sorbose, rhamnose, sorbitol, xylose and xylulose. Many such substances are soluble in water and detectable by enzymatic tests. See, e.g., U.S. patent application Ser. No. 10/471,815 (“Method for Sample Identification in a Mammal as Well as a Kit for Performing This Method”), filed 14 Mar. 2002 by Ruprecht Keller, at ¶28. Keller also mentions the use of isoprenoids, lipids, saccharides, polyols, polyethylene glycols, derivatives or mixtures of these substances as markers. See id. at ¶29. Recognizable carbohydrate compounds such as these can likewise be used in embodiments described herein, whether natural or artificial. See, e.g., Cerling et al., “Stable Isotopes in Elephant Hair Document Migration Patterns and Diet Changes,” PNAS, vol. 103, pp 371-37 (10 Jan. 2006). In some embodiments, samples 139 are chopped or ground finely (such as by sectioner 145, e.g.) to disintegrate cells, plates, and other structures in an outgrowth before solvents 136 or other reagents 135 are applied via array assay 137.

Operation 647 describes generating a temporal or directional orientation of the signal by detecting in the outgrowth at least an indication of a first and a second of the one or more reference time values (e.g., timing logic 113 identifying “forward” responsive to determining that a later-marked pulse in function 324 is found to the right of an earlier-marked pulse in function 314) In some embodiments, an orientation identifier has a value of “right side up,” “distal,” “proximal,” “opposite,” “older,” “toward the root,” “true,” “false,” or some other indicator describing which end of a sample or signal is which.

Operation 649 describes receiving user input indicating approximately a time of entry of the one or more markers into a portion of a subject's body (e.g. user interface 150 receiving a key press in response to showing “swallow the marker capsule” and “hit any key to continue” via display 151). In this example, user interface 150 can transmit reference time value(s) 118 based on when such a key press occurs, for example by estimating the key press as substantially simultaneous with a marker absorption or with the capsule entering the subject's stomach. In another embodiment, user interface 150 receives time-indicative numerical data from user 160 as a response to asking the user when a marker was or will be injected or inhaled into a subject's circulatory or respiratory system.

Some embodiments can likewise be performed without operation 649. Recording logic 110 can assume a time of entry, for example, absent the user input. This time can likewise be established, verified, or negated by sensing module 180 in some embodiments, such as by checking for a signal from a marker-containing “smart capsule.” (Such a capsule can include a small transmitter responsive to one or more sensors that can detect a suddenly dark environment and/or a temperature of about 37° C., for example.)

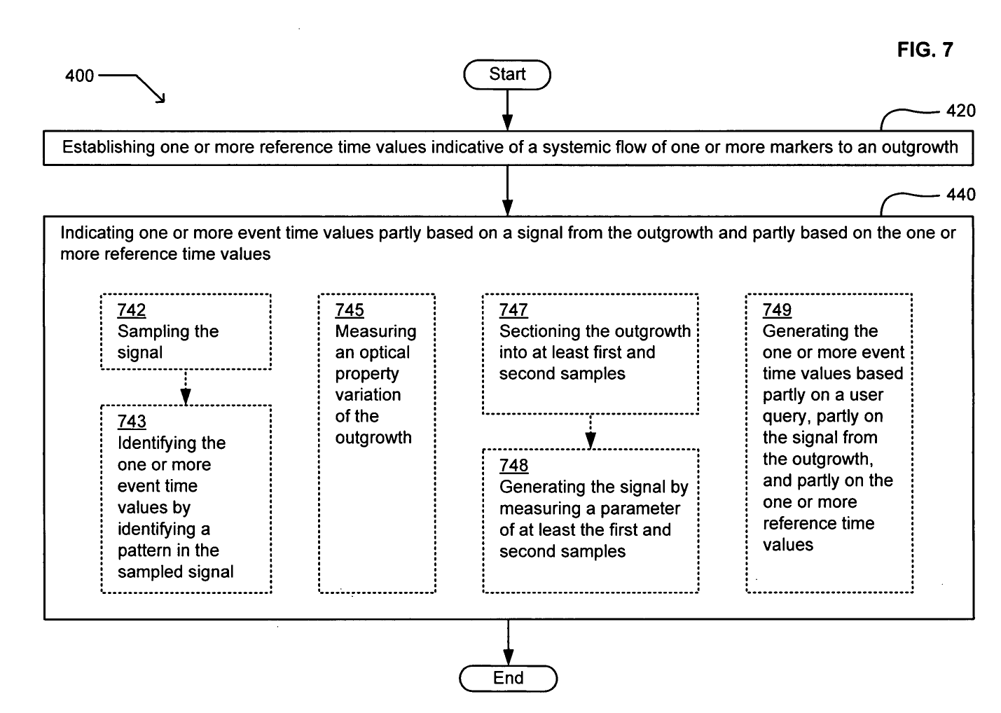

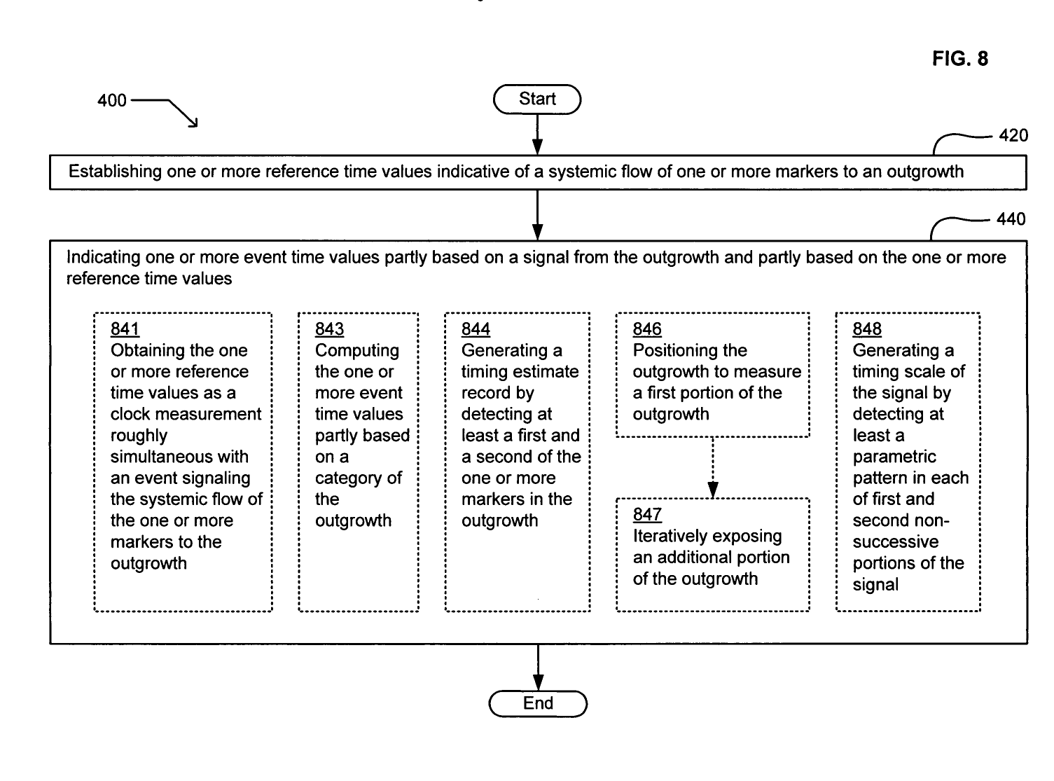

Referring now to FIG. 7, there are shown several variants of the flows 400 of FIG. 4, FIG. 5 or FIG. 6. Operation 440—indicating one or more event time values partly based on a signal from the outgrowth and partly based on the one or more reference time values—may include one or more of the following operations: 742, 743, 745, 747, 748, or 749. Operation 742 describes sampling the signal (e.g. timing logic 113 receiving an analog reading via receiver 114 and generating digital samples comprising measurement data 115.

Operation 743 describes identifying the one or more event time values by identifying a pattern in the sampled signal (e.g. processor 111 detecting a pulse pattern as exemplified in function 314 or a level change pattern as exemplified in function 334).

Operation 745 describes measuring an optical property variation of the outgrowth (detecting a pulse pattern by configuring transducer 242 to receive a detectable visual indication of iodine and scanning hair 220 along its length).

Operation 747 describes sectioning the outgrowth into at least first and second samples (e.g. sectioner 145 slicing disk-shaped portions like portion 271 and portion 272 to become the samples). In some embodiments, the samples comprise ground or dissolved portions of the outgrowth.

Operation 748 describes generating the signal by measuring a parameter of at least the first and second samples (e.g. spectrophotometer 187 measuring an emission spectrum of portion 271 and portion 272 or of samples 139 of array assay 137).

Operation 749 describes generating the one or more event time values based partly on a user query, partly on the signal from the outgrowth, and partly on the one or more reference time values (e.g., recording logic 110 responding to a user request by estimating when an elephant was poisoned at least partly based on a signal from a tusk or hair and an indication that an artificial marker was injected on May 11). The user query may include one or more of an identification of the elephant, an identification of the poison, or an identification of the sample type. In some embodiments, user input 152 may include one or more of these as responses to one or more queries transmitted to user 160 via display 151. Alternatively or additionally, one or more of these items may be obtained by analyzing measurement data 115.

In some embodiments, user interface 150 can receive user input 152 including an artificial marking time as a reference time value. Recording logic 110 can likewise transmit a message indicating a relative time, indicating for example that a systemic flow of interest (including the poison, e.g.) was about 2 days, 13 hours, and 35 minutes before a reference flow (of a dye, e.g.) via display 151.

Referring now to FIG. 8, there are shown several variants of the flows 400 of FIG. 4, FIG. 5, FIG. 6, or FIG. 7. Operation 440—indicating one or more event time values partly based on a signal from the outgrowth and partly based on the one or more reference time values—may include one or more of the following operations: 841, 843, 844, 846, 847, or 848. Operation 841 describes obtaining the one or more reference time values as a clock measurement roughly simultaneous with an event signaling the systemic flow of the one or more markers to the outgrowth (e.g., recording logic 110 responding to receiving an event-indicative signal transition from user interface 150 or sensing module 180 by latching a then-current hour of “14:45” from timing logic 113). Timing logic 113 can include an oscillator or a receiver of a clock signal external to analyzer system 170, for example. The indicated event can be an input from user 160 or (outgrowth-indicative) measurement data 115 obtained via receiver 114, for example. The clock value can be recorded with reference time value(s) 118 of event record 116, for example.

Operation 843 describes computing the one or more event time values partly based on a category of the outgrowth (e.g., processor 111 computing an estimate of 11:00 A.M. responsive to detecting a radioactive deposit 5.500 millimeters offset from another marker injected into a mammal exactly ten days later.) In some embodiments, computing operation 843 can be performed by processor 111 applying model 112 (a linear projection with a rate dependent on user input 152, e.g.).

Alternatively or additionally, processor 111 may apply a nominal growth rate or other model 112 that depends on a subject's gender, the subject's age, a hair type, a race, or another sample-specific or otherwise subject-specific attribute. Model 112 can include a rate table indicating nominal values of 0.55 mm/day for male elephants, 0.35 mm/day for a human scalp hair, or 0.16 mm/day for human eyelashes, for example. In other embodiments, recording logic 110 can affirm or enhance the projection's accuracy by extrapolating or interpolating the exposure time (of an isotope exposure, e.g.) based on event record 116 indicating more than one marker being introduced at different times (two of the reference time value(s) 118 separated by 48.0 hours, e.g.). In still other embodiments, a non-linear model is used to account for growth phase outgrowth rate variations based on an a priori model or on several markers introduced at various times of a single season or week. The non-linear model can account for growth phases such as a period of no growth, for example.

Operation 844 describes generating a timing estimate record by detecting at least a first and a second of the one or more markers in the outgrowth. Recording logic 110 can receive and store approximate reference time value(s) 118 respectively for a red marker and a blue marker in a toenail, for example. Recording logic 110 can then determine that an indication that an event “of interest” was closer to a first time than a second time, for example, responsive to detecting that a natural marker signaling the event of interest was closer to the red marker than to the blue marker. Recording logic 110 can likewise generate event time value(s) 119 indicating estimates or time ranges for a red-marker systemic flow, a blue-marker-systemic flow, and the event of interest, in some embodiments.

Operation 846 describes positioning the outgrowth to measure a first portion of the outgrowth (e.g. IR microscope 188 generating an image in which the one or more reference time values are automatically or visually apparent). Sensing module 180 can generate such images using light source controller 182, store them in recorder 189, and later transmit them to receiver 114 in some embodiments, for example. Alternatively or additionally, receiver 114 can obtains an outgrowth-indicative signal from remote equipment via interface 181.

Operation 847 describes iteratively exposing an additional portion of the outgrowth (e.g., sectioner 145 exposing surface 214 and the mating surface and similar end surfaces by chopping or slicing at systematic intervals). This can yield outgrowth samples (like those of FIG. 3, e.g.) to which recording logic 110 can apply one or more criteria to detect a signal pulse or trend, for example. Recording logic 110 can detect that a significant drop in parameter 331 occurred at 4:22 P.M., for example, corresponding to position 336. In some contexts, a very coarse sectioning may be useful, for example in determining whether a detectable level of a marker is present in a first outgrowth sample at all. This can help in one or more ways in some embodiments: by increasing a measurement sensitivity, by reducing or determining a volume of the outgrowth used for enabling detection, or by eliminating any need for testing a second sample or forming a model 112, for example.

Operation 848 describes generating a timing scale of the signal by detecting at least a parametric pattern in each of first and second non-successive portions of the signal (e.g., timing logic 113 indicating an amount of time that corresponds with sampling interval 361 at least partly based on an offset between position 316 and position 326). In some embodiments, such a measurement can validate or enhance model 112.

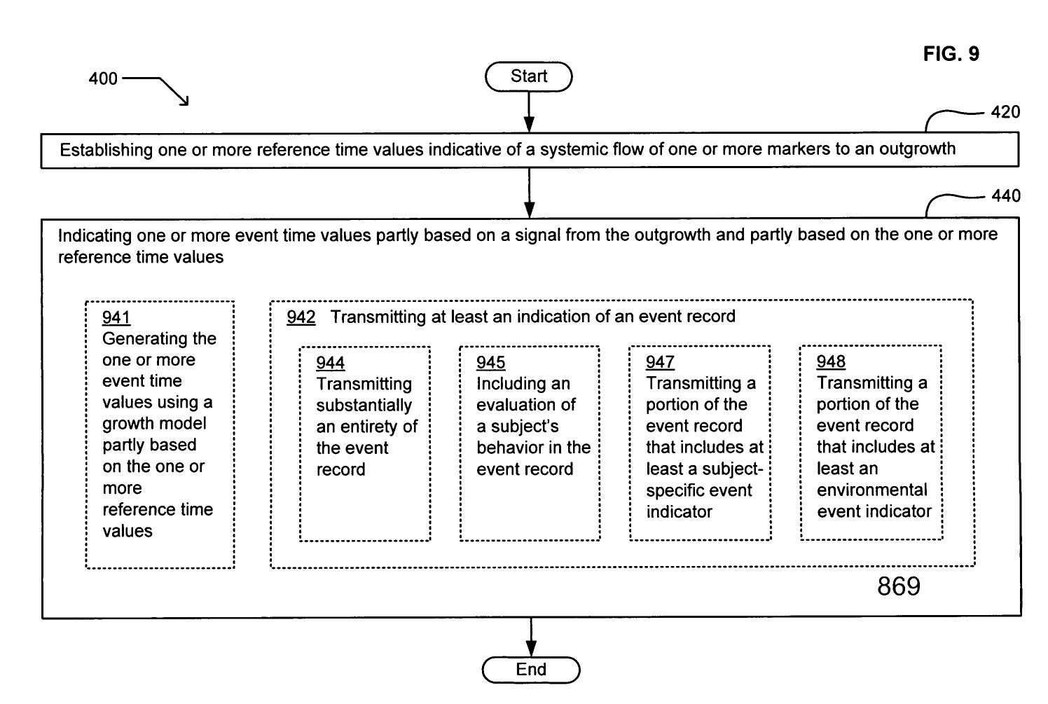

Referring now to FIG. 9, there are shown several variants of the flows 400 of FIG. 4, FIG. 5, FIG. 6, FIG. 7 or FIG. 8. Operation 440—indicating one or more event time values partly based on a signal from the outgrowth and partly based on the one or more reference time values—may optionally include one or more of the following operations: 941 or 942.

Operation 941 describes generating the one or more event time values using a growth model partly based on the one or more reference time values (e.g. processor 111 applying a ratio for converting a growth distance to a time interval or other computation, or vice versa, for a given sample or class of outgrowths). For outgrowths having a long and longitudinally steady growth phase, such a growth model can enhance accuracy, especially where applied in interpolating or upon a sample from which the ratio was generated. In one example in which parameter 311 drops from a value of 60 to a value of 29 over one sampling interval 361, for example, a metabolization rate can be obtained as this (negative) slope. Assuming that a marker concentration increased drastically just after sample 372 was obtained, one skilled in the art can readily estimate a peak concentration time and a peak value of parameter 311 (higher than 79) to the left of position 316.

Operation 942 describes transmitting at least an indication of an event record (e.g. event record 116 can include an estimate of 10:17 A.M. in a set of listed event time values 119, optionally storing or transmitting each with a corresponding one or more event description components as event type 117). In some embodiments, operation 942 is performed by recording logic 110 transmitting one or more of reference time value(s) 118 as event time value(s) 119. Event type 117 may comprise items ordinarily found in a medical history or a clinical study, in some embodiments, such as descriptive information specific to a subject, a symptom, a graphic, a marker, a measurement, or a measuring entity. Alternatively or additionally, each event record 116 may contain any number of measurements corresponding time values. Operation 942 may likewise include one or more of the following operations: 944, 945, 947, or 948.

Operation 944 describes transmitting substantially an entirety of the event record (e.g. recording logic 110 using a current state of event record 116 to update a virtual copy, not shown). In some embodiments, a current state of model 112 or measurement data 115 can likewise be transmitted, for example by way of support for an event record presented by an expert in a trial).

Operation 945 describes including an evaluation of a subject's behavior in the event record (e.g. recording logic 110 transmitting “A+” or “100%” to indicate that a patient was fully compliant with a regimen requiring a daily dosage responsive to detecting a corresponding set of entries in the event record). In some embodiments, processor 111 generates such an evaluation partly based on one or more natural markers, for example as demonstrated by one or more natural markers indicating a sufficiently low and consistent level of carbohydrate consumption for a given time period.

Operation 947 describes transmitting a portion of the event record that includes at least a subject-specific event indicator (e.g., recording logic 110 transmitting event record 116 including one or more event time values 119 as well as a name or number describing a subject or a sample of a subject to which the one or more event time values 119 relate). The subject-specific identifier can optionally identify the subject uniquely, in some embodiments, such as by including a subject's social security number. In other embodiments, the subject-specific identifier is only sufficient to identify the subject uniquely within a given class, such as by including only one of an employer name or an employee number.

Operation 948 describes transmitting a portion of the event record that includes at least an environmental event indicator. Event record 116 can include an indication that a radioactive material or other toxin was widespread on July 30, for example.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

While particular aspects of the present subject matter described herein have been shown and described, it will be apparent to those skilled in the art that, based upon the teachings herein, changes and modifications may be made without departing from this subject matter described herein and its broader aspects and, therefore, the appended claims are to encompass within their scope all such changes and modifications as are within the true spirit and scope of this subject matter described herein.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Moreover, “can” and “optionally” and other permissive terms are used herein for describing optional features of various embodiments. These terms likewise describe selectable or configurable features generally, unless the context dictates otherwise.

The herein described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality. Any two components capable of being so associated can also be viewed as being “operably couplable” to each other to achieve the desired functionality. Specific examples of operably couplable include but are not limited to physically mateable and/or physically interacting components and/or wirelessly.

1. A method comprising:
establishing one or more reference time values indicative of a systemic flow of one or more markers to an outgrowth; and
indicating one or more event time values partly based on a signal from the outgrowth and partly based on the one or more reference time values.

2. (canceled)

3. (canceled)

4. The method of claim 1, in which establishing one or more reference time values indicative of a systemic flow of one or more markers to an outgrowth comprises:
using a human-made substance as the one or more markers.

5. (canceled)

6. (canceled)

7. (canceled)

8. The method of claim 1, in which indicating one or more event time values partly based on a signal from the outgrowth and partly based on the one or more reference time values comprises:
substantially completely obtaining the signal from the outgrowth while the outgrowth remains attached to a subject.

9. The method of claim 1, in which indicating one or more event time values partly based on a signal from the outgrowth and partly based on the one or more reference time values comprises:
applying a reagent to one or more samples that each contain the one or more markers.

10. (canceled)

11. (canceled)

12. (canceled)

13. (canceled)

14. The method of claim 1, in which indicating one or more event time values partly based on a signal from the outgrowth and partly based on the one or more reference time values comprises:
sectioning the outgrowth into at least first and second samples; and
generating the signal by measuring a parameter of at least the first and second samples.

15. The method of claim 1, in which indicating one or more event time values partly based on a signal from the outgrowth and partly based on the one or more reference time values comprises:
generating the one or more event time values based partly on a user query, partly on the signal from the outgrowth, and partly on the one or more reference time values.

16. (canceled)

17. (canceled)

18. (canceled)

19. (canceled)

20. (canceled)

21. (canceled)

22. (canceled)

23. (canceled)

24. The method of claim 22, in which transmitting at least an indication of an event record comprises:
including an evaluation of a subject's behavior in the event record.

25. The method of claim 22, in which transmitting at least an indication of an event record comprises:
transmitting a portion of the event record that includes at least a subject-specific event indicator.

26. The method of claim 22, in which transmitting at least an indication of an event record comprises:
transmitting a portion of the event record that includes at least an environmental event indicator.

27. A system comprising:
means for establishing one or more reference time values indicative of a systemic flow of one or more markers to an outgrowth; and
means for indicating one or more event time values partly based on a signal from the outgrowth and partly based on the one or more reference time values.

28. The system of claim 27, in which the means for establishing one or more reference time values indicative of a systemic flow of one or more markers to an outgrowth comprises:
means for obtaining an indication of the one or more markers or of a precursor of the one or more markers.

29. The system of claim 27, in which the means for establishing one or more reference time values indicative of a systemic flow of one or more markers to an outgrowth comprises:
means for receiving an indication of a mode of detecting the one or more markers.

30. (canceled)

31. The system of claim 27, in which the means for establishing one or more reference time values indicative of a systemic flow of one or more markers to an outgrowth comprises:
means for detecting the one or more markers by applying a testing mode at least partly based on user input.

32. The system of claim 27, in which the means for establishing one or more reference time values indicative of a systemic flow of one or more markers to an outgrowth comprises:
means for obtaining a structure type indicator of the outgrowth.

33. The system of claim 27, in which the means for indicating one or more event time values partly based on a signal from the outgrowth and partly based on the one or more reference time values comprises:
means for receiving an analog input by moving a sensor relative to the outgrowth; and
means for generating the signal by sampling the analog input.

34. (canceled)

35. (canceled)

36. The system of claim 27, in which the means for indicating one or more event time values partly based on a signal from the outgrowth and partly based on the one or more reference time values comprises:
means for generating a temporal or directional orientation of the signal by detecting in the outgrowth at least an indication of a first and a second of the one or more reference time values.

37. The system of claim 27, in which the means for indicating one or more event time values partly based on a signal from the outgrowth and partly based on the one or more reference time values comprises:
means for receiving user input indicating approximately a time of entry of the one or more markers into a portion of a subject's body.

38. The system of claim 27, in which the means for indicating one or more event time values partly based on a signal from the outgrowth and partly based on the one or more reference time values comprises:
means for sampling the signal; and
means for identifying the one or more event time values by identifying a pattern in the sampled signal.

39. The system of claim 27, in which the means for indicating one or more event time values partly based on a signal from the outgrowth and partly based on the one or more reference time values comprises:
means for measuring an optical property variation of the outgrowth.

40. (canceled)

41. (canceled)

42. The system of claim 27, in which the means for indicating one or more event time values partly based on a signal from the outgrowth and partly based on the one or more reference time values comprises:
means for obtaining the one or more reference time values as a clock measurement roughly simultaneous with an event signaling the systemic flow of the one or more markers to the outgrowth.

43. The system of claim 27, in which the means for indicating one or more event time values partly based on a signal from the outgrowth and partly based on the one or more reference time values comprises:
means for computing the one or more event time values partly based on a category of the outgrowth.

44. The system of claim 27, in which the means for indicating one or more event time values partly based on a signal from the outgrowth and partly based on the one or more reference time values comprises:
means for generating a timing estimate record by detecting at least a first and a second of the one or more markers in the outgrowth.

45. The system of claim 27, in which the means for indicating one or more event time values partly based on a signal from the outgrowth and partly based on the one or more reference time values comprises:
means for positioning the outgrowth to measure a first portion of the outgrowth; and means for iteratively exposing an additional portion of the outgrowth.

46. The system of claim 27, in which the means for indicating one or more event time values partly based on a signal from the outgrowth and partly based on the one or more reference time values comprises:
means for generating a timing scale of the signal by detecting at least a parametric pattern in each of first and second non-successive portions of the signal.

47. The system of claim 27, in which the means for indicating one or more event time values partly based on a signal from the outgrowth and partly based on the one or more reference time values comprises:
means for generating the one or more event time values using a growth model partly based on the one or more reference time values.

48. The system of claim 27, in which the means for indicating one or more event time values partly based on a signal from the outgrowth and partly based on the one or more reference time values comprises:
means for transmitting at least an indication of an event record.

49. (canceled)

50. (canceled)

51. (canceled)

52. (canceled)

53. A system comprising:
circuitry for establishing one or more reference time values indicative of a systemic flow of one or more markers to an outgrowth; and
circuitry for indicating one or more event time values partly based on a signal from the outgrowth and partly based on the one or more reference time values.

54. The system of claim 53, in which the circuitry for establishing one or more reference time values indicative of a systemic flow of one or more markers to an outgrowth comprises:
circuitry for obtaining an indication of the one or more markers or of a precursor of the one or more markers.

55. The system of claim 53, in which the circuitry for establishing one or more reference time values indicative of a systemic flow of one or more markers to an outgrowth comprises:
circuitry for receiving an indication of a mode of detecting the one or more markers.

56. (canceled)

57. The system of claim 53, in which the circuitry for establishing one or more reference time values indicative of a systemic flow of one or more markers to an outgrowth comprises:
circuitry for detecting the one or more markers by applying a testing mode at least partly based on user input.

58. The system of claim 53, in which the circuitry for establishing one or more reference time values indicative of a systemic flow of one or more markers to an outgrowth comprises:
circuitry for obtaining a structure type indicator of the outgrowth.

59. The system of claim 53, in which the circuitry for indicating one or more event time values partly based on a signal from the outgrowth and partly based on the one or more reference time values comprises:
circuitry for receiving an analog input by moving a sensor relative to the outgrowth; and
circuitry for generating the signal by sampling the analog input.

60. (canceled)

61. (canceled)

62. The system of claim 53, in which the circuitry for indicating one or more event time values partly based on a signal from the outgrowth and partly based on the one or more reference time values comprises:
circuitry for generating a temporal or directional orientation of the signal by detecting in the outgrowth at least an indication of a first and a second of the one or more reference time values.

63. The system of claim 53, in which the circuitry for indicating one or more event time values partly based on a signal from the outgrowth and partly based on the one or more reference time values comprises:
circuitry for receiving user input indicating approximately a time of entry of the one or more markers into a portion of a subject's body.

64. The system of claim 53, in which the circuitry for indicating one or more event time values partly based on a signal from the outgrowth and partly based on the one or more reference time values comprises:
circuitry for sampling the signal; and
circuitry for identifying the one or more event time values by identifying a pattern in the sampled signal.

65. The system of claim 53, in which the circuitry for indicating one or more event time values partly based on a signal from the outgrowth and partly based on the one or more reference time values comprises:
circuitry for measuring an optical property variation of the outgrowth.

66. (canceled)

67. (canceled)

68. The system of claim 53, in which the circuitry for indicating one or more event time values partly based on a signal from the outgrowth and partly based on the one or more reference time values comprises:
circuitry for obtaining the one or more reference time values as a clock measurement roughly simultaneous with an event signaling the systemic flow of the one or more markers to the outgrowth.

69. The system of claim 53, in which the circuitry for indicating one or more event time values partly based on a signal from the outgrowth and partly based on the one or more reference time values comprises:
circuitry for computing the one or more event time values partly based on a category of the outgrowth.

70. The system of claim 53, in which the circuitry for indicating one or more event time values partly based on a signal from the outgrowth and partly based on the one or more reference time values comprises:
circuitry for generating a timing estimate record by detecting at least a first and a second of the one or more markers in the outgrowth.

71. The system of claim 53, in which the circuitry for indicating one or more event time values partly based on a signal from the outgrowth and partly based on the one or more reference time values comprises:
circuitry for positioning the outgrowth to measure a first portion of the outgrowth; and
circuitry for iteratively exposing an additional portion of the outgrowth.

72. The system of claim 53, in which the circuitry for indicating one or more event time values partly based on a signal from the outgrowth and partly based on the one or more reference time values comprises:
circuitry for generating a timing scale of the signal by detecting at least a parametric pattern in each of first and second non-successive portions of the signal.

73. The system of claim 53, in which the circuitry for indicating one or more event time values partly based on a signal from the outgrowth and partly based on the one or more reference time values comprises:
circuitry for generating the one or more event time values using a growth model partly based on the one or more reference time values.

74. The system of claim 53, in which the circuitry for indicating one or more event time values partly based on a signal from the outgrowth and partly based on the one or more reference time values comprises:
circuitry for transmitting at least an indication of an event record.

75. (canceled)

76. (canceled)

77. (canceled)

78. (canceled)
